(19) United States
(12) Patent Application Publication
(10) Pub. No.: US 2015/0043162 A1
(43) Pub. Date: Feb. 12, 2015

(54) CENTRAL PROCESSING UNIT CASING

(71) Applicant: WAH HONG INDUSTRIAL CORP., KAOHSIUNG (TW)

(72) Inventors: Ko-Chun CHEN, Kaohsiung City (TW); Wen-Hsiung HUANG, Tainan City (TW); Pei-Min YANG, Kaohsiung City (TW); Chun-Chang LIANG, Kaohsiung City (TW)

(21) Appl. No.: 13/964,818

(22) Filed: Aug. 12, 2013

(51) Int. Cl. G06F 1/20

(52) U.S. Cl. CPC G06F 1/203
USPC 361/679.55; 174/377; 361/704

(57) ABSTRACT

An electromagnetic interference (EMI) shield for reducing the electromagnetic interference and substantially uniformly distribute heat is disclosed. The EMI shield comprises a first layer configured to shield EMI and a second layer configured to dissipate heat. The EMI shield further comprises an interface. Some embodiments also provide methods for shielding EMI and uniformly dissipate heat of an electronic component.

### BACKGROUND OF THE INVENTION

Electromagnetic (EM) radiation generated by internal electronic components can interrupt electronic operations and cause electronic devices to malfunction. This is electromagnetic interference (EMI). As operating frequencies increase and the electronic devices become more complex, they may be more susceptible to electromagnetic interference (EMI).

EMI shields are commonly implemented in a design to isolate one component or section of an electronic device from another or to protect circuitry in an electronic component from a source external to the component (including other electronic components). The EMI shield can either be soldered to or clip on to the contact points on the component.

To ensure a reliable and robust electromagnetic seal, the EMI shield encloses the entire electromagnetic radiation component of the electronic device, such as a central processing unit (CPU) or an integrated circuit. The heat generated by the internal component, such as a CPU, will accumulate in the EMI shield and adversely affect the performance of the internal component. Openings or apertures on the EMI shields provide ventilation addresses the problem of heat accumulation. However, these features can undermine shielding effectiveness. Thus, there is a need for EMI shields that have improved heat dissipation property and shielding effectiveness.

### BRIEF SUMMARY OF THE INVENTION

Some embodiments provide an EMI shield, wherein the shield is configured to substantially uniformly distribute heat throughout the shield when one side of the shield is exposed to a heat source that creates a temperature imbalance between the side of the shield more exposed to the heat source and an opposite side of the shield less exposed to the heat source. In one exemplary embodiment, the EMI shield comprises a first layer configured to shield EMI and a second layer configured to dissipate heat.

Some embodiments provide an apparatus comprising an EMI shield.

Some embodiments are directed to an apparatus comprising a means for shielding electromagnetic interference (EMI) and substantially uniformly dissipating heat; and an electronic component at least one of shielded by the means for shielding EMI or emitting EMI that is shielded by the means for shielding EMI. The means substantially uniformly dissipate heat when one side of the means is exposed to the electronic component that creates a temperature imbalance between the side of the means more exposed to the electronic component and an opposite side of the means less exposed to the electronic component.

Another embodiment provides a portable electronic device, such as a laptop computer, a desktop computer, a hand-held communications device, etc., comprising: a motherboard; a central processing unit (CPU) supported on a first side of the motherboard; and an EMI shield surrounding the sides of the CPU not surrounded by the motherboard, the shield including: a first layer configured to shield EMI; and a second layer configured to dissipate heat, wherein the shield is configured to substantially uniformly distribute heat throughout the shield when one side of the shield is exposed to a heat source that creates a temperature imbalance between the side of the shield more exposed to the heat source and an opposite side of the shield less exposed to the heat source, wherein the shield is configured such that when the CPU outputs 2.5 watts of thermal energy over a time period where heat transfer from the CPU to the shield has reached saturation and such that the CPU has a surface temperature of 68.5 degrees C. at a first location about 0.5 mm from the shield, a temperature distribution of the shield is such that the closest point to the first location on an opposite side of the shield having 60×60 mm² geometrically centered about the first location and facing away from the shield is at about 50 degrees C. and locations of the shield on that side furthest away from the closest point have a temperature within the range of about 48 to about 50 degrees C.

Embodiments are also directed to methods of reducing external surface temperature of an electronic component and reducing EMI to and from the component using the EMI and impact resistant shield. The method includes the following actions:
(a) transferring heat from the component to the EMI shield, wherein the EMI shield is in heat transfer communication with the component;
(b) substantially uniformly dissipating the heat transferred from the component to the EMI shield in the planar direction of the EMI shield;
(c) reducing EMI from the component into ambient environment relative to that which would be the case in the absence of the EMI shield.

### BRIEF DESCRIPTION OF THE DRAWINGS

Other utilities of some embodiments will become apparent in the following detailed description of the embodiments, with reference to the accompanying drawings, in which:

FIG. 1 illustrates schematically a cross sectional view of one embodiment of the EMI shield 1. The EMI shield 1 comprises the following layers: a first layer configured to shield EMI 2 and a second layer to dissipate heat 3, joined at 4.

FIG. 2 illustrates schematically a cross sectional view of another embodiment of the EMI shield 1. The EMI shield 1 comprises the following layers: a first layer configured to shield EMI 2 and a second layer to dissipate heat 3, joined by an interface 4A.

FIG. 3 illustrates the top angle view of one embodiment of the EMI shield 1.

FIG. 4 illustrates schematically a cross sectional view of the EMI shield 1 in FIG. 3 and an electrical component 5.

FIG. 5 illustrates schematically a cross sectional view of one exemplary heat dissipation pathway of the EMI shield in FIG. 4.

FIG. 6 illustrates schematically a cross sectional view of an EMI shield 1 supported on a motherboard 6, and the EMI shield 1 surrounding the sides of the electronic component 5 not surrounded by the motherboard 6 and various detection points (H, L, M, R, and O) in working example 1.

### DETAILED DESCRIPTION OF THE INVENTION

### Definition

As employed above and throughout the disclosure, the following terms, unless otherwise indicated, shall be understood to have the following meanings.

As used herein, the singular forms “a,” “an,” and “the” include the plural reference unless the context clearly indicates otherwise.

### The EMI Shield

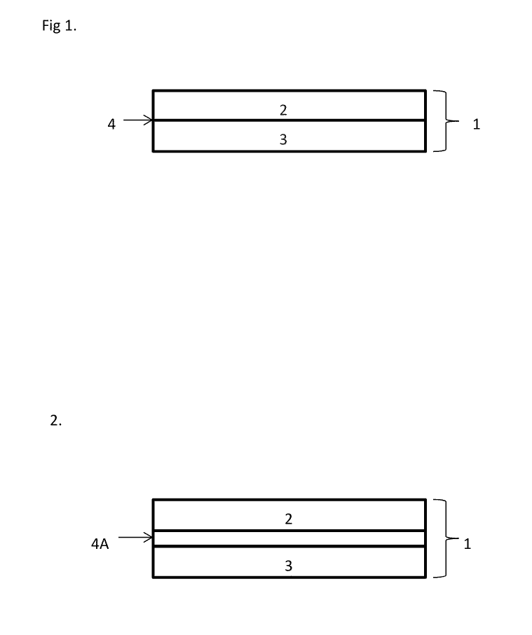

As illustrated in FIG. 1, an exemplary embodiment of the EMI shield 1 comprises a first layer configured to shield EMI 2 (or EMI shielding layer) and a second layer configured to dissipate heat 3 (or heat dissipation layer).

In another exemplary embodiment, as illustrated in FIG. 2, one or more interfaces 4A are interpose between the EMI shielding layer 2 and the heat dissipation layer 3.

In some embodiments, the EMI shielding layer 2 and the heat dissipation layer 3 are connected at 4, by one of the following processes: lamination, coating (requires one or more interfaces 4A) and electroplating (requires one or more interfaces 4A). The thickness of the EMI shield 1 is at least 20 um in some embodiments. In one embodiment, the thickness of the EMI shielding layer 2 and heat dissipation layer 3 of the EMI shield 1 are the same. In another embodiment, the thickness of the EMI shielding layer 2 and heat dissipation layer 3 of the EMI shield 1 are different.

In one embodiment, by forming the EMI shield 1 in this manner, anisotropic thermal conductivity is achieved by the juxtaposition of an EMI shielding layer 2 and isotropic heat dissipation layer 3.

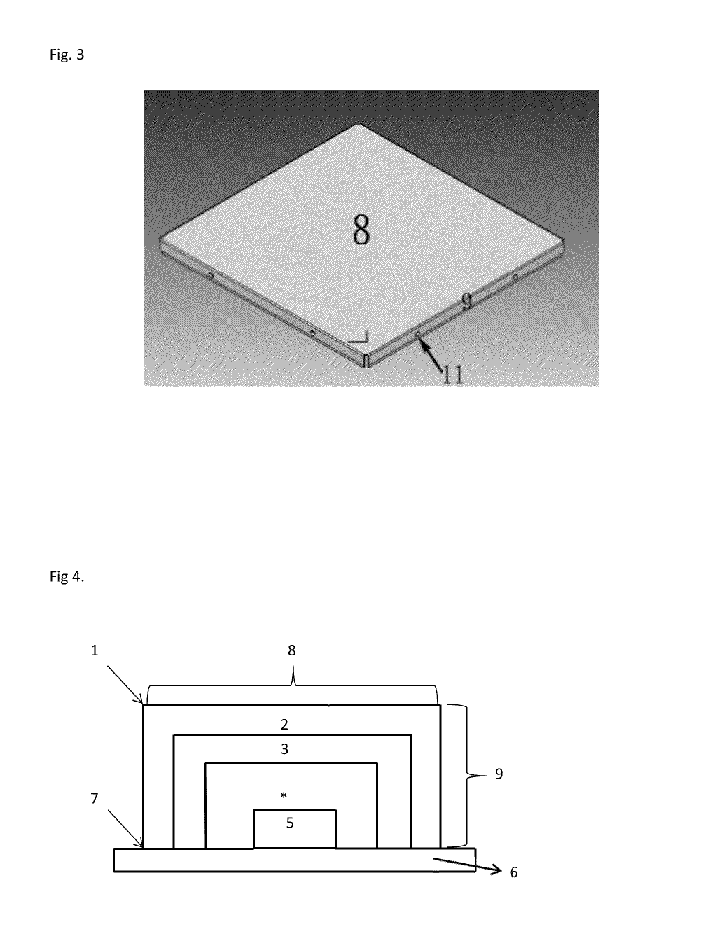

In one exemplary embodiment, as illustrated in FIG. 3, the EMI shield 1 comprises a substantially planar major surface 8 and one or more side walls 9. In some embodiments, there are openings 11 on the side walls 9 of the EMI shield 1, as illustrated in FIG. 3. In one exemplary embodiment, these openings are for supporting the EMI shield 1 onto the mother board 6. In another exemplary embodiment, the substantially planar major surface 8 of the EMI shield 1 is substantially free of apertures or openings 11 and hence, is more effective in EMI shielding than EMI shield with apertures or openings on the substantially planar major surface 8.

Referring to FIG. 4, the EMI shield 1 in some embodiments is in direct physical contact with the mother board 6 at 7 and surrounds the sides of the electronic component 5 not surrounded by the motherboard 6 (i.e., to encase a heat source or an internal component of an electronic device 5). In other embodiments, the EMI shield is in indirect contact with the mother board 6 at 7 (i.e. the EMI shield 1 is positioned at the predetermined interval from the mother board 6) and surrounds the sides of the electronic component 5 not surrounded by the motherboard 6. The EMI shield 1 is in contact with the mother board by 6 soldering or by a clip on means. In one exemplary embodiment, the distance between the inner surface of the EMI shield 1 and the top surface of the heat source 5 (denoted by * in FIG. 4) is at least 0.05 mm, to avoid the EMI shield 1 denting the enclosed heat source 5.

Referring to FIG. 6, some embodiments provide one or more strengthening ribs on the outer surface of the EMI shield 1, in the gap between the inner surface of the outer casing 10 and the outer surface of the EMI shield 1, thus strengthening the EMI shield 1.

In one group of embodiments, the EMI shield 1 uniformly distributes the heat over the shield 1 when one side of the shield is exposed to a heat source that creates a temperature imbalance between the side of the shield more exposed to the heat source and an opposite side of the shield less exposed to the heat source.

In one embodiment, the EMIS shield 1 is configured such that a heat source outputting 2.5 watts of thermal energy having a surface saturation temperature of 68.5 degrees C. at a location closest to the EMI shield 1 and about 0.5 mm from the EMIS shield 1 results in a temperature distribution of the shield such that the closest point to the location on an opposite side of the EMI shield 1 having 60×60 mm² geometrically centered about the location and facing away from the EMI shield 1 is at about 50 degrees C. and locations of the EMI shield 1 on that side furthest away from the closest point have a temperature within the range of about 48 to about 50 degrees C.

In some embodiments, the EMI shield 1 has a shield effectiveness for EMI over a range of about 50 MHz to about 4.2 GHz falls within a range of about 88 dB to about 75 dB.

In an exemplary embodiment, there is a portable electronic device, such as a laptop, having a housing/casing, having an interior height of less than 2 inches, less than 1.5 inches, less than 1.0 inches, less than 0.75 inches, less than 0.5 inches or any vale or range of values therebetween in 0.1 inch increments (e.g., 1.8 inches, 0.7 inches, 0.6 inches to 1.2 inches, etc), and a width and length of larger dimensions, in which housing any or all of the components detailed herein are located with the respective height, width and length at least substantially aligned in the same manner. An example of such housing or casing is the base of a laptop having a keyboard or other user interface, where, in an exemplary embodiment of such exemplary housing, the base is movably attached a liquid crystal display.

### EMI Shielding Layer

In one exemplary embodiment, EMI Shielding layer 2 shields EMI and is substantially flat.

The term “substantially flat” as used herein to describe surfaces of the EMI shielding layer 2 or heat dissipation layer 3 refers to a surface that does not touch the side of the electronic component 5 surrounded by the EMI shield 1. A substantially flat surface can include a flat surface having various surface characteristics that do not touch the side of the electronic component 5 surrounded by the EMI shield 1. In addition, the substantially flat surfaces can have slight curvature as long as such curvature does not cause the EMI shield 1 to touch the side of the electronic component 5 surrounded by the EMI shield 1. The substantially flat surfaces of the EMI shielding layer 2 or heat dissipation layer 3 can have defined or rounded edges.

In an exemplary embodiment, the thickness of the EMI shielding layer 2 is equal to or more than about 10 μm. In another exemplary embodiment, the EMI shielding layer 2 has one or more of the following characteristics: heat dissipation, ductility, elasticity, forming or spinning property.

In one exemplary embodiment, the EMI shielding layer 2 is selected from stainless steel, aluminum, nickel silver, tin plate, tin coated steel, bass, an alloy, or a combination thereof. In another exemplary embodiment, the EMI shielding layer 2 is stainless steel.

### Heat Dissipation Layer

In one exemplary embodiment, heat dissipation layer 3 substantially uniformly dissipates heat throughout the EMI shield 1 and is substantially flat. In some embodiments, the heat dissipation layer 3 dissipates heat in an anisotropic direction, i.e., high in the direction parallel to the major faces of the heat dissipation layer 3 (in-plane conductivity) and substantially less in the direction transverse to the major surfaces of the heat dissipation layer 3 (through-plane conductivity).

In an exemplary embodiment, the thickness of the heat dissipation layer 3 is equal to or more than about 10 μm.

In one exemplary embodiment, the heat dissipation layer 3 is selected from copper, aluminum, nickel silver, tin plate, tin coated steel, bass, an alloy, or a combination thereof. In another exemplary embodiment, the heat dissipation layer 3 is copper.

### Interface

An interface 4A is disposed between the EMI shielding layer 2 and the heat dissipation layer 3. Suitable interfaces 4A include, but are not limited to, adhesive and graphite. The adhesive is a double-sided adhesive tape, including a pressure sensitive adhesive coating and a release liner. Examples of suitable adhesives useful in at least some embodiments include, but are not limited to, 3M 6T16 adhesive and 3M 6602 adhesive, both are commercially available from 3M, USA.

In some embodiments, the graphite interface 4A can be prepared from natural, synthetic or pyrolytic graphite particles. An example of natural graphite used in at least some embodiments includes, but is not limited to, flexible exfoliated graphite (made by treating natural graphite flakes with substances that intercalate into the crystal structure of the graphite). The thermal conductivity of the graphite sheet is anisotropic. In an exemplary embodiment, anisotropic ratio of the graphite sheet, defined as the ratio of in-plane conductivity to through-plane conductivity, is between about 2 to about 800. The graphite sheet can be about 0.01 mm to about 0.5 mm.

### Methods of Reducing External Surface Temperature of Electronic Component and EMI

Methods of reducing external surface temperature of an electronic component and reducing EMI from the electronic component using the EMI shield 1 are provided in some embodiments. The method includes the following actions:
(a) transferring heat from the component to the EMI shield, wherein the EMI shield is in heat transfer communication with the component;
(b) substantially uniformly dissipating the heat transferred from the component through the planar direction of the EMI shield;
(c) reducing the EMI from the component into ambient environment relative to that which would be the case in the absence of the EMI shield.

In some embodiments, the methods further comprise the action of reducing the EMI from the ambient environment into the component relative to that which would be the case in the absence of the EMI shield.

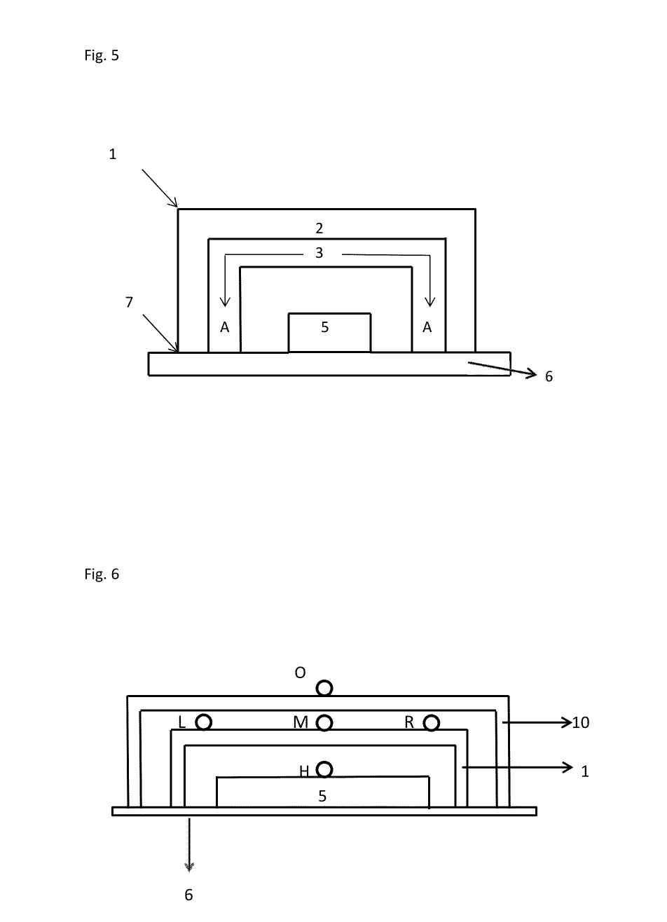

FIG. 5 illustrates one exemplary heat transfer pathway of the EMI shield 1 to uniformly distribute the heat over the EMI shield 1. In one exemplary embodiment, the EMI shield 1 is in direct physical contact with a mother board 6 at 7, and surrounds the sides of the internal component 5 not in contact with the motherboard 6 (i.e. to encase an internal component of an electronic device 5). In another exemplary embodiment, the EMI shield 1 is in indirect contact with the mother board 6 at 7 and surrounds the sides of the internal component 5 not surrounded by the motherboard 6. Non limiting examples of the mother board 6 include a printed circuit board (PCB), or a PCB mechanically supports and electrically connects electronic components, using conductive pathways, tracks or signal traces etched from copper sheets laminated onto a non-conductive substrate. Non limiting examples of the internal or electronic component include CPU, GPU, Wifi, Power Integrated Circuit, 3G or other chipset drivers with heat power more than 100 mw.

In one embodiment, heat from the internal component 5 is then transferred to the EMI shield 1, wherein the heat spreads across the planar direction (i.e. anisotropic direction) of the EMI shield 1. In another embodiment, heat from the internal component 5 is then transferred to the EMI shield 1, wherein the heat spreads across the planar direction (i.e. anisotropic direction) of the heat dissipation layer 1 (pathways A in FIG. 5).

In one exemplary embodiment, by juxtaposition of an EMI shield layer 2 and an isotropic heat dissipation layer 3 (such as copper), the heat dissipation layer 5 becomes anisotropic whereby the heat can spread across the planar direction of the heat dissipation layer 3 (pathways A in FIG. 5).

In one exemplary embodiment, the EMI shield 1 uniformly distributes the heat over the EMI shield 1 if its temperature distribution ratio is less than about 15% when one side of the EMI shield 1 is exposed to the electronic component with a surface temperature of 60° C. or higher and the other side of the EMI shield is exposed to no more than 50% of the heat of the electronic component. In another exemplary embodiment, the EMI shield 1 uniformly distributes the heat if its temperature distribution ratio is equal to or less than about 14%, 13%, 12%, 11%, 10%, 9%, 8%, 7%, 6%, 5%, 4%, 3%, 2% or 1% or any value or range of values therebetween in 0.1% increments (e.g., about 2.5%, about 4.5%, about 2.6% to about 4.6%, etc.). The temperature distribution ratio based on a 6 cm×6 cm EMI shield is defined as follows: (maximum measured temperature of the EMI shield 1−minimum measured temperature of the EMI shield 1)/minimum measured temperature of the EMI shield 1.

In another exemplary embodiment, the EMI shield 1 uniformly distribute the heat over the shield 1 if the difference of the maximum measured temperature of the EMI shield 1 and the minimum measured temperature of the EMI shield 1 is equal to or less than about 10° C., 9° C., 8° C., 7° C., 6° C., 5° C., 4° C., 3° C., 2° C., 1° C. and/or any value or range of values therebetween in 0.1° C. increments (e.g., about 2.2° C., about 4.4° C., about 2.2° C. to about 3.3° C., etc.).

The following examples further illustrate some embodiments. These examples are intended merely to be illustrative and are not to be construed as being limiting.

### EXAMPLE 1

### Thermal Modeling Study Using the EMI Shield

A heat source 5 was placed in direct contact with a mother board 6 for this study and three types of EMI shields 1 were used:
1. a stainless steel EMI shield (thickness=0.2 mm) without any opening;
2. a copper EMI shield (thickness=0.2 mm) without any opening; and
3. an EMI shield comprises a stainless steel layer (thickness at least one of 0.5 mm, 0.45 mm, 0.4 mm, 0.35 mm, 0.3 mm, 0.25 mm, 0.2 mm, 0.15 mm, 0.1 mm, or 0.05 mm) and a copper layer (thickness at least one of 0.3 mm, 0.25 mm, 0.2 mm, 0.15 mm, 0.1 mm, 0.09 mm, 0.08 mm, 0.07 mm, 0.06 mm, 0.05 mm, 0.04 mm, 0.03 mm, 0.02 mm or 0.01 mm)), without any opening.

FIG. 6 illustrates the placement of the EMI shield 1 in relation to the heat source 5 and the outer casing 10 for this study.

In this study, the heat source 5 was about 25.4 mm(length)×25.4 mm(width)×0.5 mm (height) and the heat power was about 2.5 watts. The EMI shield 1 was about 60 mm(length)×60 mm(width)×1 mm(height) and interposed between the heat source 5 and an outer casing 10. The distance between the inner surface of the EMI shield 1 and the outer surface of the heat source 5 was about 0.5 mm, and the distance between the outer surface of the EMI shield 1 and the inner surface of the outer casing 10 was about 2 mm.

The heater source 5 was pre-heated to 80° C. prior to the commencement of the study. The temperature was measured after 2 hours using a thermometer (YOKOGAWA DX-2048, Tokyo, Japan). The temperature was measured at points H, L, M, R, and O in FIG. 6. The study results are summarized in Tables 1 to 4.

TABLE 1
The Temperature of the Heat Source at
Point H Using 3 Different EMI Shields.

| | Heat Source Temp | Heat Source Temp | Temperature |
|---|---|---|---|
| | At Beginning | After 2 Hours | Reduction |
| EMI Shield | (° C.) | (° C.) | (° C.) |
| Stainless Steel | 80.2 | 73.4 | 6.8 |
| Copper | 80.2 | 71.9 | 8.3 |
| Stainless | 80.2 | 67.8 | 12.4 |
| Steel + | | | |
| Copper | | | |

TABLE 2
The Temperature of the EMI Shield at Points
L, M and R Using 3 Different EMI shields.
EMI Shield Temp After 2 hours

| | Point L | Point M | Point R |
|---|---|---|---|
| EMI Shield | (° C.) | (° C.) | (° C.) |
| Stainless Steel | 51.3 | 66.9 | 52.0 |
| Copper | 48.3 | 49.2 | 48.0 |
| Stainless Steel + | 48.3 | 50.5 | 49.0 |
| Copper | | | |

TABLE 3
The Temperature of the Outer Casing
at Point O Using 3 Different EMI Shields.

| | Outer Casing Temp At | Outer Casing Temp | Temperature |
|---|---|---|---|
| | Beginning | After 2 hours | Increase |
| EMI Shield | (° C.) | (° C.) | (° C.) |
| Stainless | 29.0 | 45.0 | 16.0 |
| Steel | | | |
| Copper | 29.0 | 39.0 | 10.0 |
| Stainless | 29.0 | 38.6 | 9.6 |
| Steel + | | | |
| Copper | | | |

TABLE 4
The EMI Shielding Effectiveness of 3 Different
EMI Shields at various electromagnetic frequencies.

| Shielding | | | % of Shielding |
|---|---|---|---|
| Effectiveness | (dB) | Frequency | Effectiveness |
| SUS | 54.903 | 80 MHz~3 GHz | 99.884% |
| Copper | 51.286 | 80 MHz~3 GHz | 99.684% |
| TS-Mike@xy | 54.723 | 80 MHz~3 GHz | 99.822% |
| SUS | 47.017 | 3 GHz~4.2 GHz | 99.473% |
| Copper | 43.634 | 3 GHz~4.2 GHz | 99.244% |
| TS-Mike@xy | 46.493 | 3 GHz-4.2 GHz | 99.438% |

The results show that the stainless steel+copper EMI shield according to one embodiment has a temperature distribution ratio of about 4.6% and is more efficient in heat dissipation compare to a stainless steel EMI shield or a copper EMI shield. In addition, heat is uniformly distributed over the EMI shield using the stainless steel+copper EMI shield according to one embodiment. This is illustrated by a small temperature difference (from about 0.7° C. to about 2.3° C.) on the EMI shield at 2 hours. In addition, the stainless steel+copper EMI shield according to one embodiment is effective in shielding the EMI.

1. An apparatus, comprising:
an electromagnetic interference (EMI) shield, including:
a first layer configured to shield EMI; and
a second layer configured to dissipate heat anisotropically,
wherein the EMI shield is configured to substantially uniformly distribute heat throughout the EMI shield when a first side of the EMI shield is exposed to a heat source that creates a temperature imbalance between the first side of the EMI shield more exposed to the heat source and a second side of the EMI shield less exposed to the heat source,
wherein the EMI shield comprises a substantially planar structure and one or more side walls extending beyond the substantially planar structure and toward the heat source, and wherein the second layer forms part of the substantially planar structure and the one or more side walls and is disposed closer to the heat source than the first layer.

2-3. (canceled)

4. The apparatus of claim 1, wherein the first layer is a stainless steel layer.

5. (canceled)

6. (canceled)

7. The apparatus of claim 1, wherein the second layer is a copper layer.

8. The apparatus of claim 1, wherein the substantially planar structure of the EMI shield is substantially free of openings.

9. The apparatus of claim 1, further comprising one or more interfaces between the first layer and the second layer.

10. The apparatus of claim 1, wherein the EMI shield has a temperature distribution ratio of less than about 15% when the first side of the EMI shield is exposed to the heat source having a surface temperature of at least 60° C. or higher and the second side of the EMI shield is exposed to no more than 50% of a heat energy emitted from the heat source.

11. The apparatus of claim 1, wherein the first side of the EMI shield faces the heat source.

12. The apparatus of claim 1, wherein the EMI shield is configured such that when the heat source outputs 2.5 watts of thermal energy and has a surface temperature of 68.5 degrees C. at a first location on the heat source closest to the first side of the EMI shield and about 0.5 mm from the EMI shield, the closest point to the first location on the second side of the EMI shield is at about 50 degrees C. and locations of the EMI shield on the second side furthest away from the closest point have a temperature within a range of about 48 to about 50 degrees C.

13. The apparatus of claim 12, wherein the surface temperature of 68.5 degrees C. is a saturation temperature of the apparatus.

14. The apparatus of claim 12, wherein a shield effectiveness for EMI over a range of about 50 MHz to about 4.2 GHz falls within a range of about 88 dB to about 75 dB.

15. The apparatus of claim 12, wherein an average thickness of the EMI shield is about 0.2 mm.

16. The apparatus of claim 12, wherein the heat source has a surface area facing the EMI shield of about 25 mm×25 mm.

17. An apparatus, comprising:
a first means for shielding electromagnetic interference (EMI) and dissipating heat; and
an electronic component at least one of shielded by the first means and emitting EMI that is shielded by the first means,
wherein the first means comprises a first layer configured to shield EMI and a second layer configured to dissipate heat anisotropically, and
wherein the first means further comprises a substantially planar structure and one or more side walls extending beyond the substantially planar structure, the second layer being part of the substantially planar structure and the one or more side walls.
wherein the EMI shield comprises a substantially planar structure and one or more side walls extending beyond the substantially planar structure and toward the heat source, and wherein the second layer forms part of the substantially planar structure and the one or more side walls and is disposed closer to the heat source than the first layer.

18. (canceled)

19. The apparatus of claim 17, further comprising one or more interfaces between the first layer and the second layer.

20. (canceled)

21. The apparatus of claim 17, wherein the substantially planar structure is substantially free of openings.

22. The apparatus of claim 17, wherein the first means has a temperature distribution ratio of less than about 15% when a first side of the first means is exposed to the electronic component having a surface temperature of 60° C. or higher and a second side of the first means is exposed to no more than 50% of a heat energy emitted from the electronic component.

23. A method for reducing an external surface temperature of an electronic component and reducing electromagnetic interference (EMI) from the electronic component, the method comprising:
transferring heat from the electronic component to an EMI shield, wherein the EMI shield is in heat transfer communication with the electronic component;
dissipating, from the EMI shield, the heat transferred from the electronic component to the EMI shield; and
blocking at least a portion of the EMI from being transmitted from the electronic component into an ambient environment proximate to the electronic component,
wherein the EMI shield comprises a substantially planar structure and one or more side walls extending beyond the substantially planar structure and toward the heat source, and wherein the second layer forms part of the substantially planar structure and the one or more side walls and is disposed closer to the heat source than the first layer, and wherein the heat is dissipated parallel to the second layer to substantially uniformly distribute heat throughout the shield.

24. The method of claim 23, wherein the EMI shield is in contact with a motherboard and together with the motherboard, encloses the electronic component.

25. The method of claim 23, wherein the EMI shield has a temperature distribution ratio of less than about 15% when a first side of the EMI shield is exposed to the electronic component with a surface temperature at 60° C. or higher and a second side of the EMI shield is exposed to no more than 50% of the heat from the electronic component.

26. (canceled)

27. A portable electronic device, comprising:
a motherboard;
an electromagnetic interference (EMI) shield;
a central processing unit (CPU) supported on a first side of the motherboard, the CPU being enclosed by the motherboard and the EMI shield, the EMI shield including:
a first layer configured to shield EMI; and
a second layer configured to dissipate heat anisotropically,
wherein the EMI shield is configured to substantially uniformly distribute heat throughout the EMI shield when a first side of the EMI shield is exposed to a heat source that creates a temperature imbalance between the first side of the EMI shield more exposed to the heat source and a second side of the EMI shield less exposed to the heat source,
wherein the EMI shield comprises a substantially planar structure and one or more side walls extending beyond the substantially planar structure and toward the heat source, and wherein the second layer forms part of the substantially planar structure and the one or more side walls and is disposed closer to the heat source than the first layer.
